(19) United States
(12) Patent Application Publication
(10) Pub. No.: US 2009/0077337 A1
(43) Pub. Date: Mar. 19, 2009

(54) DATA READING METHOD FOR SEMICONDUCTOR MEMORY DEVICE AND SEMICONDUCTOR MEMORY DEVICE

(75) Inventor: Daisuke ODA, Tokyo (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: OKI ELECTRIC INDUSTRY CO., LTD., Tokyo (JP)

(21) Appl. No.: 12/175,493

(22) Filed: Jul. 18, 2008

(30) Foreign Application Priority Data
Sep. 14, 2007 (JP) 2007-239126

(51) Int. Cl. G06F 12/00

(52) U.S. Cl. 711/168; 711/167; 711/E12.001

(57) ABSTRACT

The present invention provides a data reading method suitable for use in a semiconductor memory device equipped with a plurality of semiconductor memory chips, which is capable of suppressing an increase in layout area as compared with a required storage capacity, and a semiconductor memory device. Two memory chips are sequentially selected in the way of combinations different from each other from within a plurality of memory chips each having a first storage area and a second storage area. Data are simultaneously read from the first storage area of one of the selected two memory chips and the second storage area of the other thereof.

### BACKGROUND OF THE INVENTION

The present invention relates to a data reading method suitable for use in a semiconductor memory device, and particularly to a data reading method suitable for use in a semiconductor memory device in which a plurality of semiconductor memory chips are mounted or implemented within a single package.

As a package for various signal processing ICs (Integrated Circuits) used in a portable device or the like, there is now known an MCP (Multiple Chip Package) in which a plurality of IC chips are disposed on a single substrate (refer to, for example, FIG. 73 of a patent document 1 (Japanese Unexamined Patent Publication No. 2003-338175)).

There is also known a semiconductor memory device wherein independent memory circuits are respectively constructed in the IC chips disposed within the MCP as described above thereby to increase storage capacity (refer to, for example, FIG. 1 of the patent document 1).

With complexity of signal processing and an improvement in accuracy, the number of data bits corresponding to one word has recently been growing. Thus, transmission lines corresponding to the number of the data bits are required to perform the transfer of data between a plurality of signal processing ICs, thereby upsizing the entire device.

Therefore, there has been adopted a transmission method wherein data corresponding to one word is transmitted on a time-sharing basis to make it possible to perform data transmission in the number of transmission lines smaller than the number of the data bits corresponding to one word between the signal processing ICs.

When, at this time, for example, read data with one word as 256 bits are outputted via transmission lines corresponding to 32 bits in the semiconductor memory device as described above, such a semiconductor memory device is constructed as described below. That is, the semiconductor memory device is comprised of two semiconductor memory chips in which memories to which data access corresponding to 128 bits can be made, and data selectors for selectively outputting 16 bits in the 128 bit data read from the memories are respectively constructed, and output terminals (32 output terminals) corresponding to 32 bits. The semiconductor memory device is output-controlled in accordance with a page access method as described below.

First, read control is simultaneously performed on the memories respectively constructed in the two semiconductor memory chips. Next, the 128-bit data respectively read from the memories by the read control are sequentially transmitted to 16 output terminals 16 bits by 16 bits in eight batches respectively. That is, data corresponding to one word (256 bits) is sequentially outputted 32 bits by 32 bits in eight batches (8-page access).

To make twice the storage capacity of the semiconductor memory device here, the two semiconductor memory chips each having the above-described configuration are further prepared as another pair. Namely, there are provided a first memory block comprised of the two semiconductor memory chips as described above, and a second memory block having the same configuration as the first memory block. One of data corresponding to 32 bits outputted from the first memory block and data corresponding to 32 bits outputted from the second memory block is selectively supplied to the 32 output terminals.

Increasing the number of memory blocks comprised of the two semiconductor memory chips described above in like manner makes it possible to increase the storage capacity to even multiples like four times and six times.

In the above access method, however, the two memory blocks, i.e., the four semiconductor memory chips must be mounted or implemented even though desired storage capacity is about 1.5 times that of the memory block. Accordingly, a problem arises in that the layout area increases as compared with the required storage capacity.

### SUMMARY OF THE INVENTION

The present invention has been made in view of the foregoing. It is therefore an object of the present invention to provide a data reading method suitable for use in a semiconductor memory device equipped with a plurality of memory chips, which is capable of suppressing an increase in layout area as compared with required storage capacity, and a semiconductor memory device.

According to a first aspect of the invention, for attaining the above object, there is provided a data reading method suitable for use in a semiconductor memory device equipped with n (where n: positive integer) memory chips respectively having first and second storage areas, comprising the steps of sequentially selecting two memory chips in the way of combinations different from each other from within the n memory chips, and reading data simultaneously from the first storage area of one of the two memory chips and the second storage area of the other thereof both selected by the chip selecting step.

According to a second aspect of the invention, for attaining the above object, there is provided a semiconductor memory device comprising n (where n: positive integer) memory chips mounted therein, which respectively read data stored at addresses indicated by common address data according to the common address data, wherein each of the memory chips includes a memory module having a first storage area and a second storage area, and storage area switching means for switching one storage area to be targeted for reading according to the address data within the first and second storage areas to the other storage area according to a chip set bit.

According to the present invention, since simultaneous access can be performed on two chips in an odd number of semiconductor memory chips, the number of the memory chips can be increased even in odd-numbered units as well as in even-numbered units. Accordingly, the mounted number of memory chips can be reduced to ensure required storage capacity as compared with the case where the number of memory chips is increased only by the even-numbered units, whereby a reduction in layout area can be achieved.

### BRIEF DESCRIPTION OF THE DRAWINGS

While the specification concludes with claims particularly pointing out and distinctly claiming the subject matter which is regarded as the invention, it is believed that the invention, the objects and features of the invention and further objects, features and advantages thereof will be better understood from the following description taken in connection with the accompanying drawings in which:

FIG. 1 is a diagram showing a configuration of a semiconductor memory device wherein the reading of data is done in accordance with a data reading method according to the present invention;

FIG. 2 is a diagram illustrating an internal configuration of a memory chip MCP shown in FIG. 1;

FIG. 3 is a diagram depicting an internal configuration of a storage area switching processing circuit 1 shown in FIG. 2;

FIG. 4 is a diagram showing a logic level inverting operation performed on an address bit AD[24] in the storage area switching processing circuit 1;

FIG. 5 is a diagram showing an internal configuration of a chip select circuit 2 shown in FIG. 2;

FIG. 6 is a diagram illustrating logic level states of chip select signals CS1 internally generated in chip select circuits 2 lying within eight memory chips MCP1 through MCP8 where they are mounted in a single package;

FIG. 7 is a diagram showing logic level states of chip select signals CS2 internally generated in chip select circuits 2 lying within three memory chips MCP1 through MCP3 where they are mounted in a single package;

FIG. 8 is a diagram illustrating an internal configuration of an input/output control circuit 3 shown in FIG. 2;

FIG. 9 is a diagram showing logic level states of an input/output control signal IO_{CON} and an input/output select signal IO_{SEL} (or IOV_{SEL}) generated in the input/output control circuit 3;

FIG. 10 is a diagram showing internal configurations of an input buffer 4 and an output buffer 5 corresponding to one bit in an input/output buffer group 200;

FIG. 11 is a diagram depicting an internal configuration of a data selector 300;

FIG. 12 is a diagram showing an internal configuration of a 3TO1 selector 14 provided in the data selector 300;

FIG. 13 is a diagram illustrating the state of allocation of read data bits D_{RD}[0] through D_{RD}[31] to output data bits Dout[0] through Dout[31], which has been done by the data selector 300;

FIG. 14 is a diagram depicting the state of allocation of input data bits Din[0] through Din[31] to write data bits D_{WR}[0] through D_{WR}[31], which has been done by the data selector 300;

FIG. 15 is a diagram representing a low address area M_{L} and a high address area M_{H} with respect to a full storage area in a memory module 100;

FIG. 16 is a diagram representing areas respectively accessible by memory modules 100 of MCP1 through MCP3, based on address data bits AD[24] and AD[25]; and

FIG. 17 is a diagram representing the states of connections between data pads D and external terminals DP in the memory modules 100 of the MCP1 through MCP3, based on the address data bits AD[24] and AD[25].

### DETAILED DESCRIPTION OF THE PREFERRED EMBODIMENTS

Two memory chips are sequentially selected in the way of combinations different from each other from within a plurality of memory chips each having first and second storage areas, and data are simultaneously read from the first storage area of one of the selected two memory chips and the second storage area of the other thereof.

Preferred embodiments of the present invention will hereinafter be described in detail with reference to the accompanying drawings.

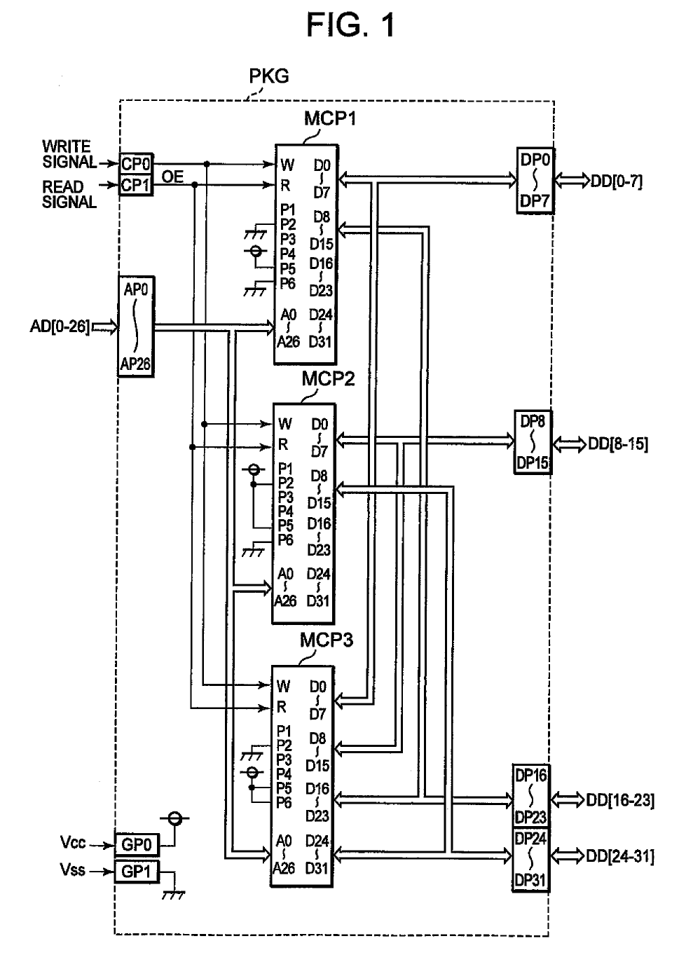

FIG. 1 is a diagram showing an overall configuration of a semiconductor memory device in which the reading of data is carried out in accordance with a data reading method according to the present invention.

In FIG. 1, three memory chips MCP1 through MCP3 capable of writing data therein and reading the same therefrom in 32-bit units respectively are included in a single package PKG employed in the semiconductor memory device.

These semiconductor memory chips MCP1 through MCP3 are formed in the package PKG and at least external terminals shown below are formed therein. Namely, there are formed, as shown in FIG. 1, external terminals GP0 and GP1 respectively supplied with a source voltage V_{CC} and a ground voltage V_{SS}, external terminals CP0 and CP1 respectively inputted with a write signal and a read signal, external terminals AP0 through AP26 respectively inputted with address data AD[0-26] of 27 bits, and external terminals DP0 through DP31 which accept the input/output of 32-bit data DD[0-31]. The source voltage V_{CC} and the ground voltage V_{SS} supplied via the external terminals GP0 and GP1 respectively are supplied to the memory chips MCP1 through MCP3 respectively. The write signal inputted via the external terminal CP0 is supplied to write signal pads W of the memory chips MCP1 through MCP3 respectively. The read signal inputted via the external terminal CP1 is supplied to read signal pads R of the memory chips MCP1 through MCP3 respectively as an output enable signal OE. The 27-bit address data AD[0-26] inputted via the external terminals AP0 through AP26 are supplied to their corresponding address pads A0 through A26 of the memory chips MCP1 through MCP3.

Data pads D0 through D7 of the memory chip MCP1 are respectively connected to pads (not shown) of the external terminals DP0 through DP7. Data pads D8 through D15 of the MCP1 are respectively connected to pads (not shown) of the external terminals DP16 through DP23.

Data pads D0 through D7 of the memory chip MCP2 are respectively connected to pads (not shown) of the external terminals DP8 through DP15. Data pads D8 through D15 of the MCP2 are respectively connected to pads (not shown) of the external terminals DP24 through DP31.

Data pads D0 through D7 of the memory chip MCP3 are respectively connected to the pads of the external terminals DP0 through DP7. Data pads D8 through D15 of the MCP3 are respectively connected to the pads of the external terminals DP8 through DP15. Further, data pads D16 through D23 of the memory chip MCP3 are respectively connected to the pads of the external terminals DP16 through DP23. Data pads D24 through D31 of the MCP3 are respectively connected to the pads of the external terminals DP24 through DP31.

Namely, the data pads D0 through D7 of the memory chips MCP1 and MCP3 are respectively connected in common to the pads of the external terminals DP0 through DP7 in the following correspondence relationships:

External terminal DP0: Data pads D0 of MCP1 and MCP3

External terminal DP1: Data pads D1 of MCP1 and MCP3

External terminal DP2: Data pads D2 of MCP1 and MCP3

External terminal DP3: Data pads D3 of MCP1 and MCP3

External terminal DP4: Data pads D4 of MCP1 and MCP3

External terminal DP5: Data pads D5 of MCP1 and MCP3

External terminal DP6: Data pads D6 of MCP1 and MCP3

External terminal DP7: Data pads D7 of MCP1 and MCP3

The data pads D0 through D7 of the memory chip MCP2 and the data pads D8 through D15 of the MCP3 are respectively connected in common to the pads of the external terminals DP8 through DP15 in the following correspondence relationships:

External terminal DP8: Data pad D0 of MCP2 and data pad D8 of MCP3

External terminal DP9: Data pad D1 of MCP2 and data pad D9 of MCP3

External terminal DP10: Data pad D2 of MCP2 and data pad D10 of MCP3

External terminal DP11: Data pad D3 of MCP2 and data pad D11 of MCP3

External terminal DP12: Data pad D4 of MCP2 and data pad D12 of MCP3

External terminal DP13: Data pad D5 of MCP2 and data pad D13 of MCP3

External terminal DP14: Data pad D6 of MCP2 and data pad D14 of MCP3

External terminal DP15: Data pad D7 of MCP2 and data pad D15 of MCP3

The data pads D8 through D15 of the memory chip MCP1 and the data pads D16 through D23 of the MCP3 are respectively connected in common to the pads of the external terminals DP16 through DP23 in the following correspondence relationships:

External terminal DP16: Data pad D8 of MCP1 and data pad D16 of MCP3

External terminal DP17: Data pad D9 of MCP1 and data pad D17 of MCP3

External terminal DP18: Data pad D10 of MCP1 and data pad D18 of MCP3

External terminal DP19: Data pad D11 of MCP1 and data pad D19 of MCP3

External terminal DP20: Data pad D12 of MCP1 and data pad D20 of MCP3

External terminal DP21: Data pad D13 of MCP1 and data pad D21 of MCP3

External terminal DP22: Data pad D14 of MCP1 and data pad D22 of MCP3

External terminal DP23: Data pad D15 of MCP1 and data pad D23 of MCP3

The data pads D8 through D15 of the memory chip MCP2 and the data pads D24 through D31 of the MCP3 are respectively connected in common to the pads of the external terminals DP24 through DP31 in the following correspondence relationships:

External terminal DP24: Data pad D8 of MCP2 and data pad D24 of MCP3

External terminal DP25: Data pad D9 of MCP2 and data pad D25 of MCP3

External terminal DP26: Data pad D10 of MCP2 and data pad D26 of MCP3

External terminal DP27: Data pad D11 of MCP2 and data pad D27 of MCP3

External terminal DP28: Data pad D12 of MCP2 and data pad D28 of MCP3

External terminal DP29: Data pad D13 of MCP2 and data pad D29 of MCP3

External terminal DP30: Data pad D14 of MCP2 and data pad D30 of MCP3

External terminal DP31: Data pad D15 of MCP2 and data pad D31 of MCP3

The memory chips MCP1 through MCP3 have internal configurations identical to one another respectively.

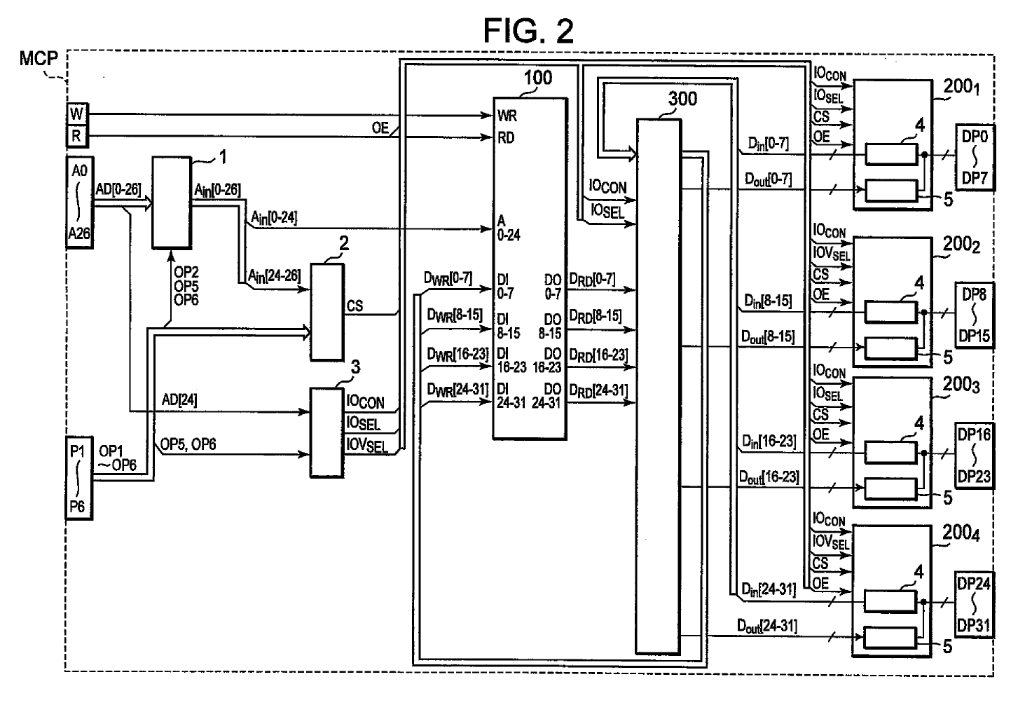

They respectively have such an internal configuration as shown in FIG. 2.

As shown in FIG. 2, each memory chip MCP includes a storage area switching processing circuit 1, a chip select circuit 2, an input/output control circuit 3, a memory module 100, input/output buffer groups 200₁ through 200₄ and a data selector 300. Further, the memory chip MCP has a power pad (not shown) for the supply of the source voltage V_{CC}, a write signal pad W, a read signal pad R, option pads P1 through P6 and address pads A0 through A26 as pads for accepting the input/output of signals from and to the outside of the chip in addition to the data pads D0 through D31. Incidentally, when a plurality of the memory chips MCP each having such a configuration as shown in FIG. 2 are operated in cooperation, the option pads P1 through P6 are provided to set access modes (to be described later) thereof individually. For example, when the source voltage V_{CC} corresponding to a logic level 1 and the ground voltage V_{SS} corresponding to a logic level 0 are respectively fixedly supplied to the option pads P2, P5 and P6 in such a form as shown in FIG. 1, the memory chips MCP1, MCP2 and MCP3 are respectively set to ┌first, second and third access modes┘.

The storage area switching processing circuit 1 performs the following processing on the 27-bit address data AD[0-26] supplied via the address pads A0 through A26 to generate internal addresses Ain[0-26] and supplies internal address bits Ain[0-24] corresponding to 25 bits in the internal addresses Ain[0-26] to the memory module 100. The storage area switching processing circuit 1 supplies the internal address bits Ain[24], Ain[25] and Ain[26] in the internal addresses Ain[0-26] to the chip select circuit 2.

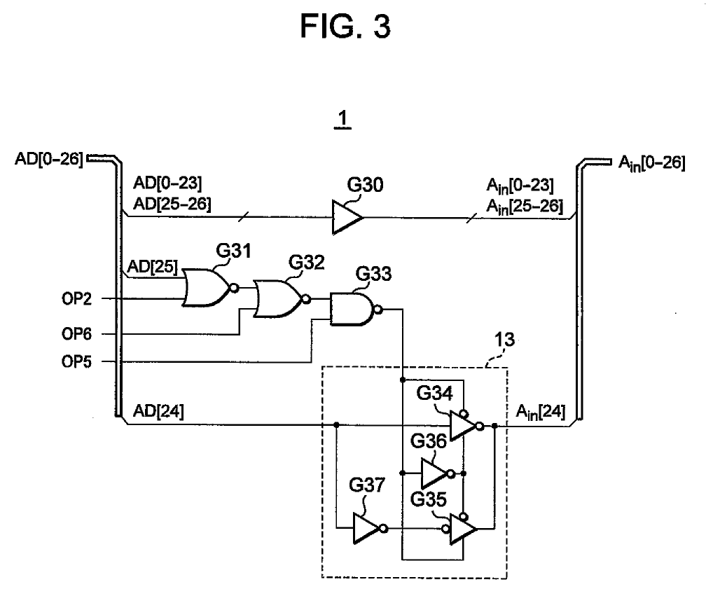

FIG. 3 is a diagram showing an internal configuration of the storage area switching processing circuit 1.

In FIG. 3, a buffer group G30 outputs 0th through 23rd bits and 25th and 26th bits excepting a 24th bit in the address data AD[0-26] supplied via the address pads A0 through A26 as the internal address bits Ain[0] through Ain[23], Ain[25] and Ain[26]. A NOR gate G31 determines the OR of the address bit AD[25] corresponding to the 25th bit in the address data AD[0-26] and a chip set bit OP2 supplied via the option pad P2 and supplies a signal obtained by inverting the logic level of the result of ORing to a NOR gate G32. The NOR gate G32 determines the OR of the signal supplied from the NOR gate G31 and a chip set bit OP6 supplied via the option pad P6 and supplies a signal obtained by inverting the logic level of the result of ORing to a NAND gate G33. The NAND gate G33 determines the AND of the signal supplied from the NOR gate G32 and a chip set bit OP5 supplied via the option pad P5 and supplies a signal obtained by inverting the logic level of the result of ANDing to a logic level inverting circuit 13. The logic level inverting circuit 13 comprises tristate buffers G34 and G35 and inverters G36 and G37. When the signal supplied from the NAND gate G33 is of a logic level 1, the tristate buffer G34 brings its output terminal to a high impedance state. On the other hand, when the signal supplied from the NAND gate G33 is of a logic level 0, the tristate buffer G34 outputs a signal obtained by the logic level of the address bit AD[24] corresponding to the 24th bit in the address data AD[0-26] from its output terminal as the internal address bit Ain[24]. The inverter G36 supplies a signal obtained by inverting the logic level of the signal supplied from the NAND gate G33 to a control terminal of the tristate buffer G35. The inverter G37 supplies a signal obtained by inverting the logic level of the address bit AD[24] to an input terminal of the tristate buffer G35. When the signal supplied from the inverter G36 is of the logic level 1, the tristate buffer G35 brings its output terminal to a high impedance state. On the other hand, when the signal supplied from the inverter G36 is of the logic level 0, the tristate buffer G35 outputs a signal obtained by inverting the logic level of the signal supplied from the inverter G37 from its output terminal as the internal address bit Ain[24]. The output terminals of the tristate buffers G34 and G35 are connected to one another. That is, when the signal supplied from the NAND gate G33 is of the logic level 1, the logic level inverting circuit 13 outputs the address bit AD[24] as the internal address bit Ain[24] as it is. On the other hand, when the signal supplied from the NAND gate G33 is of the logic level 0, the logic level inverting circuit 13 outputs a signal obtained by inverting the logic level of the address bit AD[24] as the internal address bit Ain[24].

Namely, the storage area switching processing circuit 1 outputs other address bits excepting AD[24] in the address data AD[0-26] supplied via the address pads A0 through A26 as the internal address bits Ain[0] through Ain[23], Ain[25] and Ain[26] as they are. As for the address bit AD[24] in the address data AD[0-26], however, one obtained by inverting or non-inverting the logic level of the address bit AD[24] according to [modes] determined depending on the logic levels of the chip set bits OP2, OP5 and OP6 and address bit AD[25] as described above is defined as the internal address bit Ain[24]. Namely, the storage area switching processing circuit 1 performs the following processing only on the 24th address bit AD[24] corresponding to the most significant bit of an address for determining a memory or storage address at the memory module 100 to be descried later.

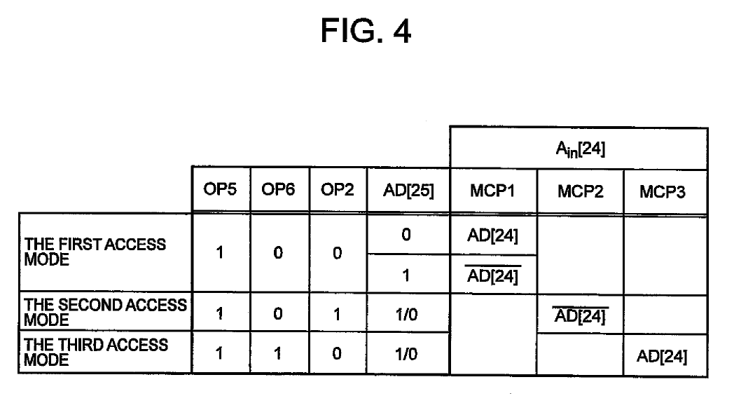

FIG. 4 is a diagram showing a processing operation for the address bit AD[24] by the storage area switching processing circuit 1.

When both the chip set bits OP5 and OP6 are of a logic level ┌1┘ and the chip set bit OP2 is of a logic level ┌0┘ as shown in FIG. 4, the processing operation is brought to ┌the third access mode┘. Thus, the storage area switching processing circuit 1 constructed in the memory chip MCP3 at this time outputs the address bit AD[24] as an internal address bit Ain[24] as it is as shown in FIG. 4. When the chip set bits OP5, OP6 and OP2 are of the logic levels ┌1┘, ┌0┘ and ┌1┘ respectively as shown in FIG. 4, the processing operation is brought to ┌the second access mode┘. Thus, the storage area switching processing circuit 1 constructed in the memory chip MCP2 at this time outputs one obtained by inverting the logic level of the address bit AD[24] as an internal address bit Ain[24] as shown in FIG. 4. When the chip set bits OP5, OP6 and OP2 are of the logic levels ┌1┘, ┌0┘ and ┌0┘ respectively as shown in FIG. 4, the processing operation is brought to ┌the first access mode┘. Thus, the storage area switching processing circuit 1 constructed in the memory chip MCP1 outputs the address bit AD[24] as an internal address bit Ain[24] as it is where the logic level of the address bit AD[25] is of the logic level ┌0┘ as shown in FIG. 4. On the other hand, when the address bit AD[25] is of the logic level ┌1┘, the storage area switching processing circuit 1 outputs one obtained by inverting the logic level of the address bit AD[24] as an internal address bit Ain[24]. At this time, the internal address bit Ain[24] assumes the most significant bit of each address in the memory module 100. Thus, when the internal address bit Ain[24] is of the logic level 0, for example, word lines that belong to a low address area where the full storage area of the memory module 100 is divided into two corresponding to a high address area and the low address area with a predetermined address as the boundary, are respectively targeted for access, and access (writing and/or reading) is made to one word line indicated by the internal address bits Ain[0] through Ain[23] from within the area. On the other hand, when the internal address bit Ain[24] is of the logic level 1, word lines that belong to the high address area of the memory module 100 are respectively targeted for access, and access (writing and/or reading) is made to one word line indicated by the internal address bits Ain[0] through Ain[23] from within the area.

Thus, in the storage area switching processing circuit 1, the logic level of the most significant address bit AD[24] at the memory module 100 is inverted according to the chip set bits (OP2, OP5 and OP6) and the Ain[25], thereby making it possible to set the access-targeted storage area (one of the high and low address areas) individually for each memory chip MCP.

The chip select circuit 2 generates a chip select signal CS for causing the memory chips MCP1 through MCP3 shown in FIG. 1 to perform a two-chip operation or a three-chip operation, based on the internal address bits Ain[24] through Ain[26] and the chip set bits OP1 through OP6 supplied via the option pads P1 through P6.

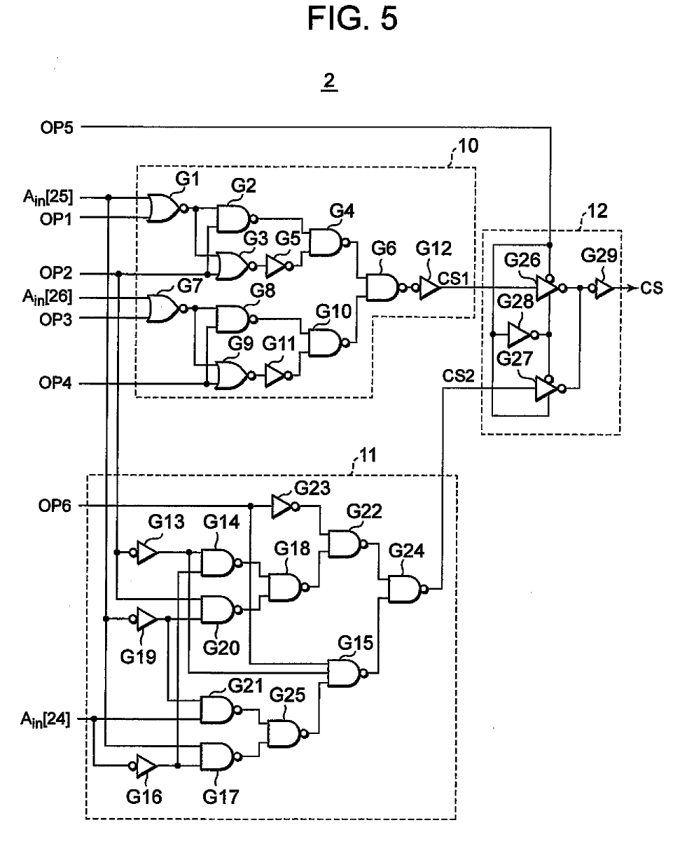

FIG. 5 is a diagram showing an internal configuration of such a chip select circuit 2.

As shown in FIG. 5, the chip select circuit 2 comprises a two-chip control unit 10, a three-chip control unit 11 and a selector 12.

A NOR gate G1 in the two-chip control unit 10 determines the OR of the internal address bit Ain[25] corresponding to the 25th bit in the internal addresses Ain[0-26] as described above and the chip set bit OP1 and supplies a signal obtained by inverting the logic level of the result of ORing to a NAND gate G2 and a NOR gate G3 respectively. The NAND gate G2 determines the AND of the signal supplied from the NOR gate G1 and the chip set bit OP2 and supplies a signal obtained by inverting the logic level of the result of ANDing to a NAND gate G4. The NOR gate G3 determines the OR of the signal supplied from the NOR gate G1 and the chip set bit OP2 and supplies a signal obtained by inverting the logic level of the result of ORing to an inverter G5. The inverter G5 supplies a signal obtained by inverting the logic level of the signal supplied from the NOR gate G3 to the NAND gate G4. The NAND gate G4 determines the AND of the signals supplied from the NAND gates G2 and the inverter G5 respectively and supplies a signal obtained by inverting the logic level of the result of ANDing to a NAND gate G6. A NOR gate G7 determines the OR of the internal address bit Ain[26] corresponding to the 26th bit in the internal addresses Ain[0-26] as described above and the chip set bit OP3 and supplies a signal obtained by inverting the logic level of the result of ORing to a NAND gate G8 and a NOR gate G9 respectively. The NAND gate G8 determines the AND of the signal supplies from the NOR gate G7 and the chip set bit OP4 and supplies a signal obtained by inverting the logic level of the result of ANDing to a NAND gate G10. The NOR gate G9 determines the OR of the signal supplied from the NOR gate G7 and the chip set bit OP4 and supplies a signal obtained by inverting the logic level of the result of ORing to an inverter G11. The inverter G11 supplies a signal obtained by inverting the logic level of the signal supplied from the NOR gate G9 to the NAND gate G10. The NAND gate G10 determines the AND of the signals respectively supplied from the NAND gate G8 and the inverter G11 and supplies a signal obtained by inverting the logic level of the result of ANDing to the NAND gate G6. The NAND gate G6 determines the AND of the signals respectively supplied from the NAND gates G4 and G10 and supplies a signal obtained by inverting the logic level of the result of ANDing to an inverter G12. The inverter G12 supplies a signal obtained by inverting the logic level of the signal supplied from the NAND gate G6 to the selector 12 as a chip select signal CS1 used where the two-chip operation is executed.

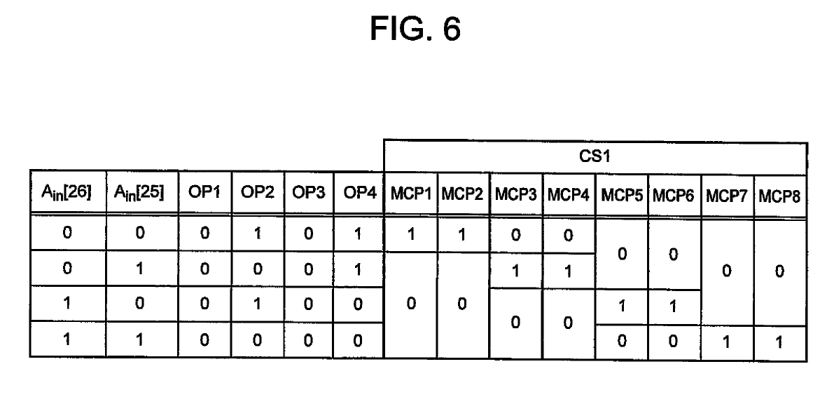

Namely, when an even number of memory chips (MCP1 through MCP8) up to eight are mounted or implemented in a single package, the two-chip control unit 10 generates a chip select signal CS1 for causing the respective memory chips to perform a two-chip operation by such combinations as shown in FIG. 6, based on the internal address bits Ain[25] and Ain[26] and the chip set bits OP1 through OP4.

When the internal address bits Ain[25] and Ain[26] and the chip set bits OP1 through OP4 are of logic levels ┌0┘, ┌0┘, ┌0┘, ┌1┘, ┌0┘ and ┌1┘ respectively in FIG. 6, for example, only the two-chip control units 10 formed within the memory chips MCP1 and MCP2 respectively generate a chip select signal CS1 having a logical level ┌1┘. When the internal address bits Ain[25] and Ain[26] and the chip set bits OP1 through OP4 are of logic levels ┌0┘, ┌1┘, ┌0┘, ┌0┘, ┌0┘ and ┌1┘ respectively, only the two-chip control units 10 formed within the memory chips MCP3 and MCP4 respectively generate a chip select signal CS1 having a logic level ┌1┘.

In FIG. 5, an inverter G13 in the three-chip control unit 11 supplies a signal obtained by inverting the logic level of the chip set bit OP2 to NAND gates G14 and G15. An inverter G16 supplies a signal obtained by inverting the logic level of the internal address bit Ain[24] to the NAND gates G14 and G17. The NAND gate G14 determines the AND of the signals supplied from the inverters G13 and G16 and supplies a signal obtained by inverting the logic level of the result of ANDing to a NAND gate G18. An inverter G19 supplies a signal obtained by inverting the logic level of the internal address bit Ain[25] to NAND gates G20 and G21. The NAND gate G20 determines the AND of the chip set bit OP2 and the signal supplied from the inverter G19 and supplies a signal obtained by inverting the logic level of the result of ANDing to the NAND gate G18. The NAND gate G18 determines the AND of the signals respectively supplied from the NAND gates G14 and G20 and supplies a signal obtained by inverting the logic level of the result of ANDing to a NAND gate G22. An inverter G23 supplies a signal obtained by inverting the logic level of the chip set bit OP6 to the NAND gate G22. The NAND gate G22 determines the AND of the signals respectively supplied from the NAND gate G18 and the inverter G23 and supplies a signal obtained by inverting the logic level of the result of ANDing to a NAND gate G24. The NAND gate G21 determines the AND of the signal supplied from the inverter G19 and the internal address bit Ain[24] and supplies a signal obtained by inverting the logic level of the result of ANDing to a NAND gate G25. The NAND gate G17 determines the AND of the internal address bit Ain[25] and the signal supplied from the inverter G16 and supplies a signal obtained by inverting the logic level of the result of ANDing to the NAND gate G25. The NAND gate G25 determines the AND of the signals respectively supplied from the NAND gates G17 and G21 and supplies a signal obtained by inverting the logic level of the result of ANDing to the NAND gate G15. The NAND gate G15 determines the AND of both the result of ANDing of the signals respectively supplied from the NAND gate G25 and the inverter G13 and the chip set bit OP6 and supplies a signal obtained by inverting the logic level of the result of ANDing to the NAND gate G24. The NAND gate G24 determines the AND of the signals respectively supplied from the NAND gates G15 and G22 and supplies a signal obtained by inverting the logic level of the result of ANDing to the selector 12 as a chip select signal CS2 used where three-chip control is carried out.

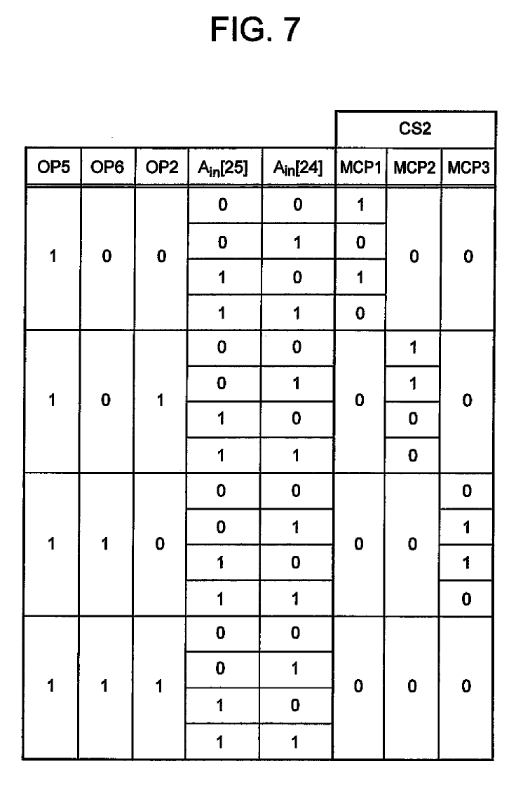

Namely, the three-chip control unit 11 generates the chip select signal CS2 for causing such three (odd number of) memory chips MCP1 through MCP3 as shown in FIG. 1 to perform the three-chip control by such combinations as shown in FIG. 7, based on the chip set bits OP2, OP5 and OP6 and the interval address bits Ain[24] and Ain[25].

As shown in FIG. 1, for example, the voltages corresponding to the logic levels ┌0┘, ┌1┘ and ┌0┘ are respectively fixedly applied to the chip set bits OP2, OP5 and OP6 in the memory chip MCP1. In the memory chip MCP2 as shown in FIG. 1, the voltages corresponding to the logic levels ┌1┘, ┌0┘ and ┌1┘ are respectively fixedly applied to the chip set bits OP2, OP5 and OP6. In the memory chip MCP3 as shown in FIG. 1, the voltages corresponding to the logic levels ┌1┘, ┌1┘ and ┌0┘ are respectively fixedly applied to the chip set bits OP2, OP5 and OP6. Thus, when the internal address bits Ain[25] and Ain[24] are respectively of the logic levels ┌0┘ and ┌0┘ as shown in FIG. 7, only the three-chip control units 11 formed within the MCP1 and MCP2 lying in the memory chips MCP1 through MCP3 respectively supply chip select signals CS2 of logic levels ┌1┘ to operate the MCP1 and MCP2 to their corresponding chip selectors 12. When the internal address bit Ain[25] and Ain[24] are respectively of the logic levels ┌0┘ and ┌1┘ as shown in FIG. 7, only the three-chip control units 11 formed within the MCP2 and MCP3 lying in the memory chips MCP1 through MCP3 respectively supply chip select signals CS2 of logic levels ┌1┘ to operate the MCP2 and MCP3 to their corresponding selectors 12. When the internal address bits Ain[25] and Ain[24] are respectively of the logic levels ┌1┘ and ┌0┘ as shown in FIG. 7, only the three-chip control units 11 formed within the MCP1 and MCP3 lying in the memory chips MCP1 through MCP3 respectively supply chip select signals CS2 of logic levels ┌1┘ to operate the MCP1 and MCP3 to their corresponding selectors 12.

The selector 12 comprises tristate buffers G26 and G27 and inverters G28 and G29. When the chip set bit OP5 is of a logic level 1, the tristate buffer G26 brings its output terminal to a high impedance state. On the other hand, when the chip set bit OP5 is of a logic level 0, the tristate buffer G26 transmits a signal obtained by inverting the logic level of the chip select signal CS1 supplied from the two-chip control unit 10 to an inverter G29 via its output terminal. When a signal supplied from the inverter G28, i.e., a signal obtained by inverting the logic level of the chip set bit OP5 is of the logic level 1, the tristate buffer G27 brings its output terminal to a high impedance state. On the other hand, when the signal obtained by inverting the logic level of the chip set bit OP5 is of the logic level 0, the tristate buffer G27 transmits a signal obtained by inverting the logic level of the chip select signal CS2 supplied from the three-chip control unit 11 to the inverter G29 via its output terminal. The inverter G29 outputs a signal obtained by further inverting the logic level of the signal obtained by inverting the logic level of the chip select signal (CS1 or CS2), which has been supplied from one of the tristate buffers G26 and G27, as a final chip select signal CS. With such a configuration, the selector 12 selects CS1 out of the chip select signals CS1 and CS2 where the chip set bit OP5 is indicative of the logic level 0 and outputs it as the chip select signal CS. On the other hand, when the chip set bit OP5 is indicative of the logic level 1, the selector 12 selects CS2 out of the chip select signals CS1 and CS2 and outputs it as the chip select signal CS. Thus, when three-chip control is performed on the three memory chips MCP1 through MCP3 shown in FIG. 1, the source voltage V_{SS} is fixedly supplied to the option pad P5 of each of the memory chips MCP1 through MCP3 as shown in FIG. 1 thereby to fix the chip set bit OP5 to the logic level ┌1┘.

As described above, the chip select circuit 2 supplies the chip select signal CS to such input/output buffer groups 200₁ through 200₄ respectively as shown in FIG. 2.

The input/output control circuit 3 generates input/output select signals IO_{SEL} and IOV_{SEL} and an input/output control signal IO_{CON} to control the input/output buffer groups 200₁ through 200₄, based on the address bit AD[24] supplied via the address pad A24 and the chip set bits OP5 and OP6.

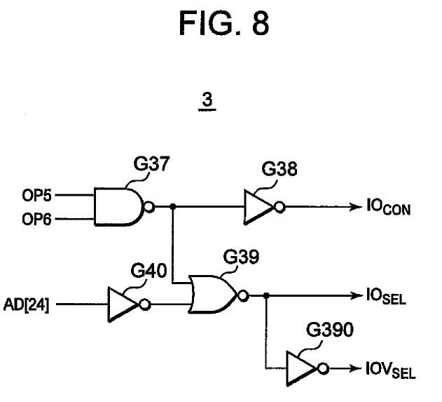

FIG. 8 is a diagram showing an internal configuration of the input/output control circuit 3.

In FIG. 8, a NAND gate G37 determines the AND of the chip set bit OP5 and the chip set bit OP6 and supplies a signal obtained by inverting the logic level of the result of ANDing to an inverter G38 and a NOR gate G39. The inverter G38 outputs a signal obtained by inverting the logic level of the signal supplied from the NAND gate G37 as an input/output control signal IO_{CON}. An inverter G40 supplies a signal obtained by inverting the logic level of the address bit AD[24] to the NOR gate G39. The NOR gate G39 determines the OR of the signal supplied from the NAND gate G37 and the signal supplied from the inverter G40 and outputs a signal obtained by inverting the logic level of the result of ORing as an input/output select signal IO_{SEL}. The inverter G39 outputs a signal obtained by inverting the logic level of the input/output select signal IO_{SEL} as an input/output select signal IOV_{SEL}.

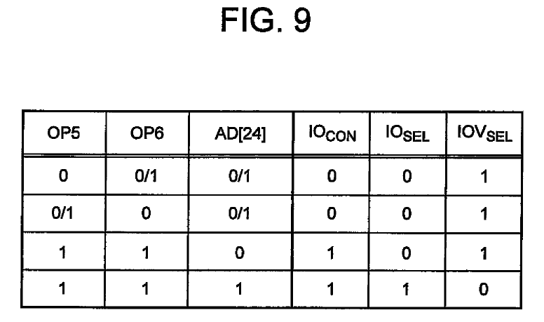

Namely, the input/output control circuit 3 generates the input/output control signal IO_{CON} and input/output select signals IO_{CON} and IOV_{SEL} respectively having the logic levels corresponding to the address bit AD[24] and the chip set bits OP5 and OP6 in accordance with such a truth value representation as shown in FIG. 9. The input/output control circuit 3 supplies the input/output control signal IO_{CON} and the input/output select signal IO_{SEL} to their corresponding input/output buffer groups 200₁ and 200₃ and data selector 300 and supplies the input/output control signal IO_{CON} and the input/output select signal IOV_{SEL} to their corresponding input/output buffer groups 200₂ and 200₄.

The memory module 100 takes or fetches write data D_{WR}[0-31] corresponding to 32 bits supplied from the data selector 300 therein via data input terminals DI[0-31] thereof in response to the write signal supplied via the write signal pad W and stores the same at their corresponding addresses indicated by the internal address bits Ain[0-24]. The memory module 100 reads the 32-bit write data D_{WR}[0-31] stored at the addresses indicated by the internal address bits Ain[0-24] in response to the output enable signal OE supplied via the read signal pad R and sends the same to the data selector 300 via data output terminals DO[0-31] as 32-bit read data D_{RD}[0-31].

The input/output buffer group 200₁ takes in 8-bit data bits supplied via their corresponding data pads D0 through D7 and supplies these to the data selector 300 as input data bits Din[0] through Din[7]. The input/output buffer group 200₁ sends 8-bit output data bits Dout[0] through Dout[7] supplied from the data selector 300 to their corresponding data pads D0 through D7. The input/output buffer group 200₂ fetches therein 8-bit data bits supplied via their corresponding data pads D8 through D15 and supplies these to the data selector 300 as input data bits Din[8] through Din[15]. The input/output buffer group 200₂ sends 8-bit output data bits Dout[8] through Dout[15] supplied from the data selector 300 to their corresponding data pads D8 through D15. The input/output buffer group 200₃ fetches therein 8-bit data bits supplied via their corresponding data pads D16 through D23 and supplies these to the data selector 300 as input data bits Din[16] through Din[23]. The input/output buffer group 200₃ transmits 8-bit output data bits Dout[16] through Dout[23] supplied from the data selector 300 to their corresponding data pads D16 through D23. The input/output buffer group 200₄ takes therein 8-bit data bits supplied via their corresponding data pads D24 through D31 and supplies these to the data selector 300 as input data bits Din[24] through Din[31]. The input/output buffer group 200₄ transmits 8-bit output data bits Dout[24] through Dout[31] supplied from the data selector 300 to their corresponding data pads D24 through D31.

The input/output buffer groups 200₁ through 200₄ respectively have the same internal configuration and perform switching between the above-described input and output operations in response to the above-described chip select signal CS, output enable signal OE, input/output control signal IO_{CON} and input/output select signal IO_{SEL} (or IOV_{SEL}).

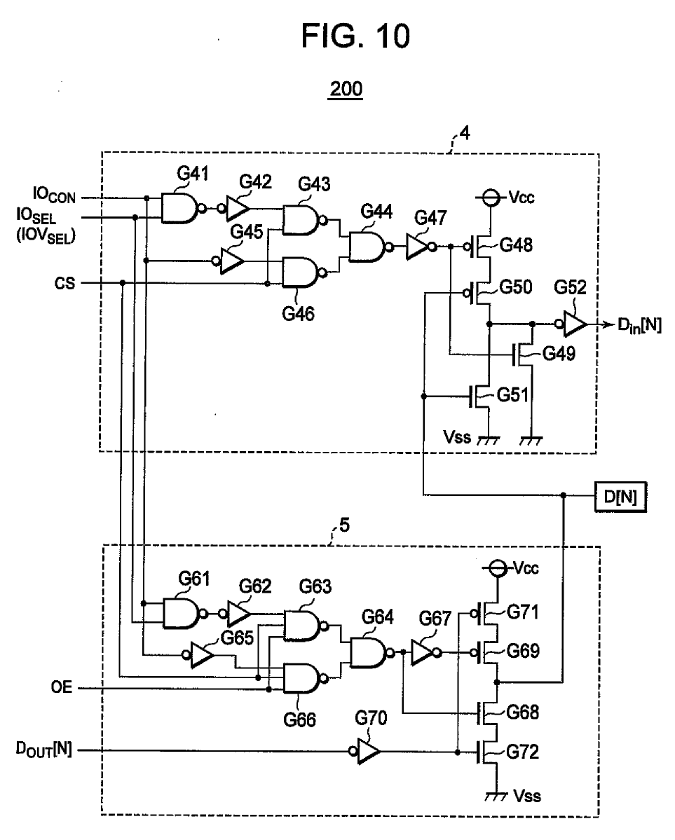

FIG. 10 is a diagram showing a configuration of an input/output buffer corresponding to one bit, which has been mounted or installed in each of the input/output buffer groups 200₁ through 200₄.

As shown in FIG. 10, the input/output buffer corresponding to one bit comprises an input buffer 4 and an output buffer 5.

In the input buffer 4, a NAND gate G41 determines the AND of the input/output select signal IO_{SEL} (or IOV_{SEL}) and the input/output control signal IO_{CON} and supplies a signal obtained by inverting the logic level of the result of ANDing to an inverter G42. The inverter G42 supplies a signal obtained by inverting the logic level of the signal supplied from the NAND gate G41 to a NAND gate G43. The NAND gate G43 determines the AND of the signal supplied from the inverter G42 and the chip select signal CS and supplies a signal obtained by inverting the logic level of the result of ANDing to a NAND gate G44. An inverter G45 supplies a signal obtained by inverting the logic level of the input/output control signal IO_{CON} to a NAND gate G46. The NAND gate G46 determines the AND of the signal supplied from the inverter G45 and the chip select signal CS and supplies a signal obtained by inverting the logic level of the result of ANDing to the NAND gate G44. The NAND gate G44 determines the AND of the signals respectively supplied from the NAND gates G43 and G46 and supplies a signal obtained by inverting the logic level of the result of ANDing to an inverter G47. The inverter G47 supplies a signal obtained by inverting the logic level of the signal supplied from the NAND gate G44 to gate terminals of a p-type transistor G48 used as a p channel type MOS (Metal Oxide Semiconductor) transistor (hereinafter called simply “p-type transistor”), and an n-type transistor G49 used as an n channel type MOS transistor (hereinafter called simply “n-type transistor”). A source voltage V_{CC} is applied to a source terminal of the p-type transistor G48, and a drain terminal thereof is connected to a source terminal of a p-type transistor G50. A drain terminal of the p-type transistor G50 is connected to both a source terminal of the n-type transistor G49 and a source terminal of an n-type transistor G51 and an input terminal of an inverter G52 respectively. A ground voltage V_{SS} is applied to drain terminals of the n-type transistors G49 and G51. When the voltage V_{CC} corresponding to a logic level 1 is applied to the input terminal of the inverter G52, the inverter G52 supplies a signal corresponding to a logic level 0 to the data selector 300 as an input data bit Din[N] (where N: 0 through 31). A gate terminal of the n-type transistor G51 and a gate terminal of the p-type transistor G50 are connected in common to a data pad D[N] (where N: 0 through 31).

Namely, as long as the chip select signal CS is of a logic level 1 and the input/output control signal IO_{CON} is of a logic level 0 or the chip select signal CS, input/output control signal IO_{CON} and input/output select signal IO_{SEL} (or IOV_{SEL}) are of the logic level 1 together, the input buffer 4 takes therein a data bit inputted via the data pad D[N] as an input data bit Din[N].

On the other hand, in the output buffer 5, a NAND gate G61 determines the AND of the input/output select signal IO_{SEL} (or IOV_{SEL}) and the input/output control signal IO_{CON} and supplies a signal obtained by inverting the logic level of the result of ANDing to an inverter G62. The inverter G62 supplies a signal obtained by inverting the logic level of the signal supplied from the NAND gate G61 to a NAND gate G63. The NAND gate G63 determines the AND of the signal supplied from the inverter G62, an output enable signal OE and the chip select signal CS and supplies a signal obtained by inverting the logic level of the result of ANDing to a NAND gate G64. An inverter G65 supplies a signal obtained by inverting the logic level of the input/output control signal IO_{CON} to a NAND gate G66. The NAND gate G66 determines the AND of the signal supplied from the inverter G65, the output enable signal OE and the chip select signal CS and supplies a signal obtained by inverting the logic level of the result of ANDing to the NAND gate G64. The NAND gate G64 determines the AND of the signals respectively supplied from the NAND gates G63 and G66 and supplies a signal obtained by inverting the logic level of the result of ANDing to an inverter G67 and a gate terminal of an n-type transistor G68. The inverter G67 supplies a signal obtained by inverting the logic level of the signal supplied from the NAND gate G64 to a gate terminal of a p-type transistor G69. An inverter G70 supplies a signal obtained by inverting the logic level of output data Dout[N] (where N: 0 through 31) supplied from the data selector 300 to gate terminals of a p-type transistor G71 and an n-type transistor G72. The source voltage V_{CC} is applied to a source terminal of the p-type transistor G71 and its drain terminal is connected to a source terminal of the p-type transistor G69. The ground voltage V_{SS} is applied to a drain terminal of the n-type transistor G72 and a source terminal thereof is connected to a drain terminal of the n-type transistor G68. A source terminal of the n-type transistor G68 and a drain terminal of the p-type transistor G69 are connected in common to the data pad D[N].

Namely, as long as the chip select signal CS, output enable signal OE, input/output control signal IO_{CON} and input/output select signal IO_{SEL} (or IOV_{SEL}) are of the logic level 1 together, or the chip select signal CS and output enable signal OE are both of the logic level 1 and the input/output control signal IO_{CON} is of the logic level 0, the output buffer 5 sends the output data Dout[N] supplied from the data selector 300 to the data pad D[N]. On the other hand, when the chip select signal CS, output enable signal OE, input/output control signal IO_{CON} and input/output select signal IO_{SEL} (or IOV_{SEL}) are respectively of a logic level other than the above, the output buffer 5 brings a connecting line to the data buffer D[N] to a high impedance state.

The data selector 300 supplies those obtained by recombining the bit order at input data Din[0-31] supplied from the input/output buffer groups 200₁ through 200₄ in 8-bit units in the following manner to the memory module 100 as write data D_{WR}[0-31], based on the input/output control signal IO_{CON} and input/output select signal IO_{SEL} (or IOV_{SEL}). Further, the data selector 300 supplies those obtained by recombining the bit order at read data D_{RD}[0-31] read from the memory module 100 in 8-bit units in the following manner to the input/output buffer groups 200₁ through 200₄ as output data Dout[0-31], based on the input/output control signal IO_{CON} and input/output select signal IO_{SEL} (or IOV_{SEL}).

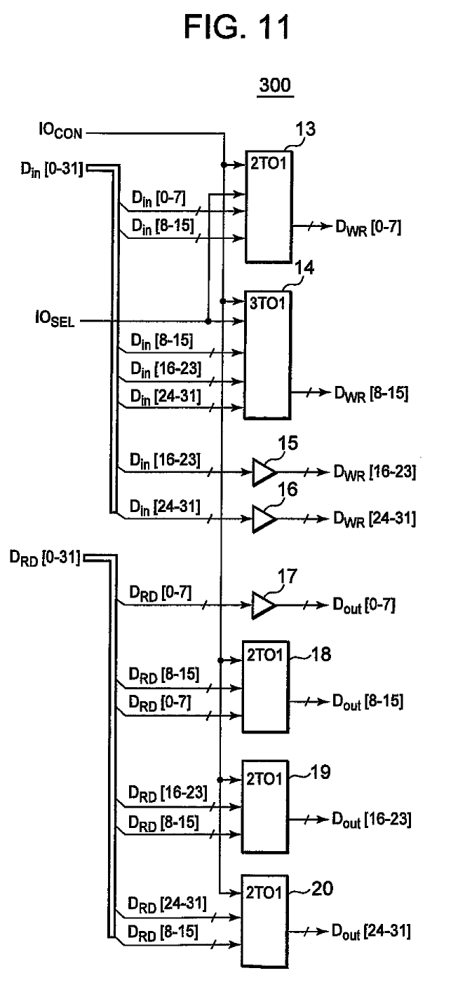

FIG. 11 is a diagram showing the configuration of the data selector 300.

When the input/output control signal IO_{CON} and input/output select signal IO_{SEL} (or IOV_{SEL}) are both of a logic level 0 or either one thereof is of a logic level 1 in FIG. 11, a 2TO1 selector 13 supplies input data bits Din[0] through Din[7] supplied from the input/output buffer group 200₁ to the memory module 100 as write data bits D_{WR}[0] through D_{WR}[7] respectively. On the other hand, when the input/output control signal IO_{CON} and the input/output select signal IO_{SEL} (or IOV_{SEL}) are both of the logic level 1, the 2TO1 selector 13 supplies input data bits Din[8] through Din[15] supplied from the input/output buffer group 200₂ to the memory module 100 as the write data bits D_{WR}[0] through D_{WR}[7] respectively.

A 3TO1 selector 14 selects input data bit groups indicated by the input/output control signal IO_{CON} and the input/output select signal IO_{SEL} (IOV_{SEL}) from within the input data bits Din[8] through Din[15] supplied from the input/output buffer group 200₂, input data bits Din[16] through Din[23] supplied from the input/output buffer group 200₃ and input data bits Din[24] through Din[31] supplied from the input/output buffer group 200₄. Then, the 3TO1 selector 14 supplies the selected 8-bit input data bits to the memory module 100 as write data bits D_{WR}[8] through D_{WR}[15] respectively.

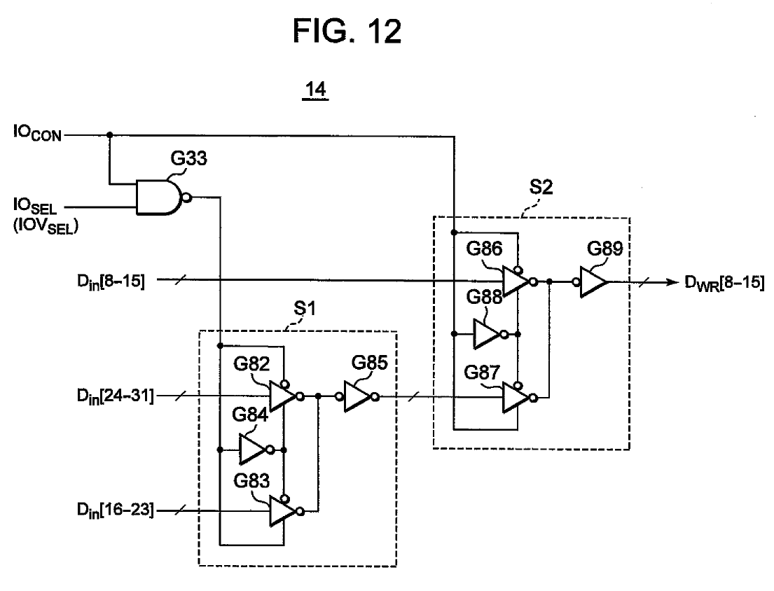

FIG. 12 is a diagram showing one example of an internal configuration of the 3TO1 selector 14.

As shown in FIG. 12, the 3TO1 selector 14 comprises a NAND gate G81 and 2TO1 selectors S1 and S2. The NAND gate G81 determines the AND of the input/output select signal IO_{SEL} (or IOV_{SEL}) and the input/output control signal IO_{CON} and supplies a signal obtained by inverting the logic level of the result of ANDing to the 2TO1 selector S1. The 2TO1 selector S1 comprises tristate buffers G82 and G83 and inverters G84 and G85. When the signal supplied from the NAND gate G81 is of a logic level 1, the tristate buffer G82 brings its output terminal to a high impedance state. On the other hand, when the signal supplied from the NAND G81 is of a logic level 0, the tristate buffer G82 sends a signal of 8 bits obtained by inverting the logic levels of the input data bits Din[24] through Din[31] to the inverter G85 via its output terminal. The inverter G84 supplies a signal obtained by inverting the logic level of the signal supplied from the NAND gate G81 to a control terminal of the tristate buffer G83. When the signal supplied from the inverter G84 is of the logic level 1, the tristate buffer G83 brings its output terminal to a high impedance state. On the other hand, when the signal supplied from the inverter G84 is of the logic level 0, the tristate buffer G83 sends a signal of 8 bits obtained by inverting the logic levels of the input data bits Din[16] through Din[23] to the inverter G85 via its output terminal. Incidentally, the output terminals of the tristate buffers G82 and G83 are connected to one another. The inverter G85 supplies a signal of 8 bits (equivalent to Din[16] through Din[23] or Din[24] through Din[31]) obtained by inverting the logic levels of the respective bits of the 8-bit signals supplied via the output terminals of the tristate buffers G82 and G83 to the 2TO1 selector S2. The 2TO1 selector S2 comprises tristate buffers G86 and G87 and inverters G88 and G89. When the input/output control signal IO_{CON} is indicative of the logic level 1, the tristate buffer G86 brings its output terminal to a high impedance state. On the other hand, when the input/output control signal IO_{CON} is of the logic level 0, the tristate buffer G86 sends a signal of 8 bits obtained by inverting the logic levels of the input data bits Din[8] through Din[15] to the inverter G89 via its output terminal. The inverter G88 supplies a signal obtained by inverting the logic level of the input/output control signal IO_{CON} to a control terminal of the tristate buffer G87. When the signal supplied from the inverter G88 is of the logic level 1, the tristate buffer G87 brings its output terminal to a high impedance state. On the other hand, when the signal supplied from the inverter G88 is of the logic level 0, the tristate buffer G87 sends a signal obtained by inverting the logic levels of the respective bits of the signal of 8 bits (equivalent to Din[16] through Din[23] or Din[24] through Din[31]) supplied from the 2TO1 selector S1 to the inverter G89 via its output terminal. The output terminals of the tristate buffers G86 and G87 are connected to one another. The inverter G89 outputs a signal of 8 bits obtained by inverting the logic levels of the respective bits of the 8-bit signals supplied to the output terminals of the tristate buffers G86 and G87 as write data bits D_{WR}[8] through D_{WR}[15].

With such a configuration, when the input/output control signal IO_{CON} is of the logic level 0, the 3TO1 selector 14 supplies the input data bits Din[8] through Din[15] supplied from the input/output buffer group 200₂ to the memory module 100 as their corresponding write data bits D_{WR}[8] through D_{WR}[15] regardless of the input/output select signal IO_{SEL} (or IOV_{SEL}). When the input/output control signal IO_{CON} is of the logic level 1 and the input/output select signal IO_{SEL} (or IOV_{SEL}) is of the logic level 0, the 3TO1 selector 14 supplies the input data bits Din[16] through Din[23] supplied from the input/output buffer group 200₃ to the memory module 100 as their corresponding write data bits D_{WR}[8] through D_{WR}[15]. When the input/output control signal IO_{CON} and input/output select signal IO_{SEL} (or IOV_{SEL}) are both of the logic level 1, the 3TO1 selector 14 supplies the input data bits Din[24] through Din[31] supplied from the input/output buffer group 200₄ to the memory module 100 as their corresponding write data bits D_{WR}[8] through D_{WR}[15]. A buffer 15 supplies the input data bits Din[16] through Din[23] supplied from the input/output buffer group 200₃ to the memory module 100 as their corresponding write data bits D_{WR}[16] through D_{WR}[23] as they are. A buffer 16 supplies the input data bits Din[24] through Din[31] supplied from the input/output buffer group 200₄ to the memory module 100 as their corresponding write data bits D_{WR}[24] through D_{WR}[31] as they are.

A buffer 17 supplies read data bits D_{RD}[0] through D_{RD}[7] read from the memory module 100 to the input/output buffer group 200₁ as their corresponding output data bits Dout[0] through Dout[7] as they are. When the input/output control signal IO_{CON} is of a logic level 0, a 2TO1 selector 18 supplies read data bits D_{RD}[8] through D_{RD}[15] read from the memory module 100 to the input/output buffer group 200₂ as their corresponding output data bits Dout[8] through Dout[15]. On the other hand, when the input/output control signal IO_{CON} is of a logic level 1, the 2TO1 selector 18 supplies the read data bits D_{RD}[0] through D_{RD}[7] read from the memory module 100 to the input/output buffer group 200₂ as their corresponding output data bits Dout[8] through Dout[15]. When the input/output control signal IO_{CON} is of the logic level 0, a 2TO1 selector 19 supplies read data bits D_{RD}[16] through D_{RD}[23] read from the memory module 100 to the input/output buffer group 200₃ as their corresponding output data bits Dout[16] through Dout[23] On the other hand, the input/output control signal IO_{CON} is of the logic level 1, the 2TO1 selector 19 supplies the read data bits D_{RD}[8] through D_{RD}[15] read from the memory module 100 to the input/output buffer group 200₃ as their corresponding output data bits Dout[16] through Dout[23]. When the input/output control signal IO_{CON} is of the logic level 0, a 2TO1 selector 20 supplies read data bits D_{RD}[24] through D_{RD}[31] read from the memory module 100 to the input/output buffer group 200₄ as their corresponding output data bits Dout[24] through Dout[31] On the other hand, when the input/output control signal IO_{CON} is of the logic level 1, the 2TO1 selector 20 supplies the read data bits D_{RD}[8] through D_{RD}[15] read from the memory module 100 to the input/output buffer group 200₄ as their corresponding output data bits Dout[24] through Dout[31]. Incidentally, each of the 2TO1 selectors 13 and 18 through 20 is realized or implemented by an internal configuration identical to that of the 2TO1 selector S2 shown in FIG. 12.

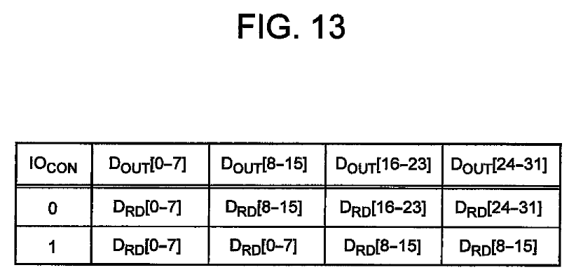

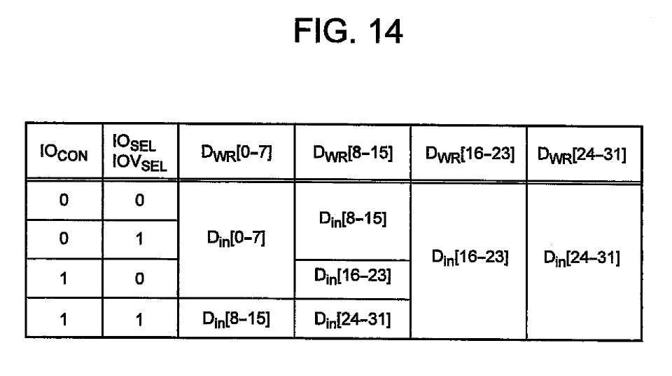

With the above configuration, the data selector 300 allocates the read data bits D_{RD}[0] through D_{RD}[31] read from the memory module 100 to their corresponding output data bits Dout[0] through Dout[31] according to the logic level of the input/output control signal IO_{CON} in such a form as shown in FIG. 13 upon data reading and sends them to the input/output buffer groups 200₁ through 200₄. On the other hand, the data selector 300 allocates the input data bits Din[0] through Din[31] supplied from the input/output buffer groups 200₁ through 200₄ to their corresponding input data bits [0] through [31] of the memory module 100 according to the logic levels of the input/output control signal IO_{CON} and input/output select signal IO_{SEL} (IOV_{SEL}) in such a form as shown in FIG. 14 and sends them to the memory module 100.

The operation of the semiconductor memory device shown in FIG. 1 in which one memory has been constructed by the three memory chips MCP (MCP1 through MCP3) each of which has such a configuration as shown in FIGS. 3 through 14 and performs such operations as shown therein, will be explained below.

Incidentally, the source voltage V_{CC} corresponding to the logic level 1 and the ground voltage V_{SS} corresponding to the logic level 0 are respectively fixedly supplied to the option pads P2, P5 and P6 of the three memory chips MCP in such a form as shown in FIG. 1, whereby the memory chips MCP1 through MCP3 are respectively set to ┌the first access mode┘, ┌the second access mode┘ and ┌the third access mode┘ respectively.

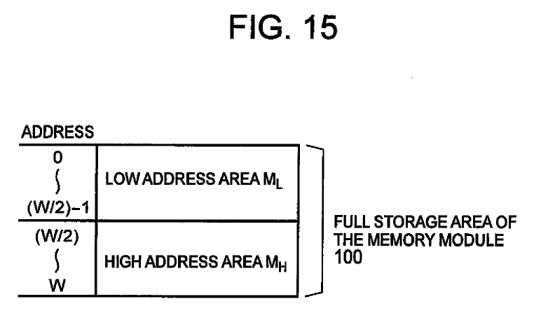

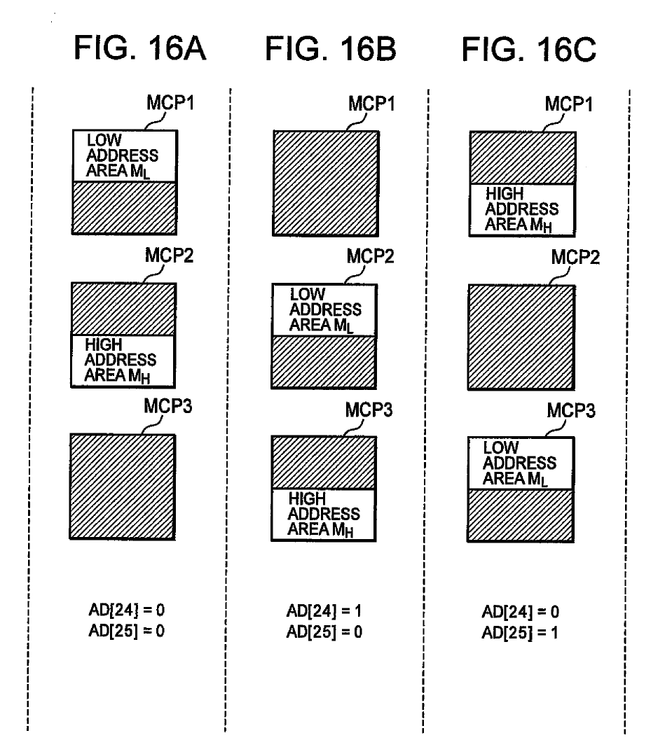

At this time, data access (writing, reading) is made to a low address area M_{L} and a high address area M_{H} obtained by dividing the full storage area of the memory module 100 into two as shown in FIG. 15, based on the address data bits AD[24] and AD[25] for each of the MCP1 through MCP3 in such forms as shown in FIGS. 16(a) through 16(c). Incidentally, as shown in FIG. 15, the low address area M_{L} corresponds to an area that belongs to each address lower than a (W/2)th address within the full storage area indicated by a 0th address through a Wth address in the memory module 100, whereas the high address area M_{H} corresponds to an area that belongs to each address higher than the (W/2)th address within the full storage area.

Now first assume that the address data bits AD[24] and AD[25] are both of a logic level 0. Thus, the internal address bits Ain[24] and Ain[25] set for each of the MCP1 through MCP3 are represented as shown in FIG. 4:

MCP1: Ain[24]=0, Ain[25]=0

MCP2: Ain[24]=1, Ain[25]=0

MCP3: Ain[24]=0, Ain[25]=0

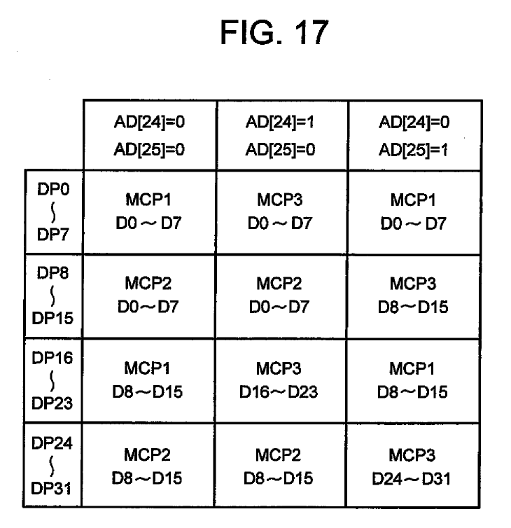

Thus, at this time, a chip select signal CS2 of a logic level 1 to make it possible to perform the input/output of data to and from the input/output buffer groups 200₁ through 200₄ only by the two MCP1 and MCP2 lying in the MCP1 through MCP3 is generated as shown in FIG. 7. Further, at the two MCP1 and MCP2 selected from within the three memory chips MCP1 through MCP3, a low address area M_{L} of the memory module 100 in the MCP1 and a high address area M_{H} of the memory module 100 in the MCP2 are targeted for access (writing, reading) as shown in FIG. 16(a). With the operation of the data selector 300 made according to FIGS. 9, 13 and 14 at this time, the data pads D0 through D7 in the memory module 100 of the MCP1 are connected to their corresponding external terminals DP0 through DP7 of the package PKG as shown in FIG. 17, and the data pads D8 through D15 in the memory module 100 of the MCP1 are connected to their corresponding external terminals DP8 through DP15. Further, as shown in FIG. 17, the data pads D0 through D7 in the memory module 100 of the MCP2 are connected to their corresponding external terminals DP8 through DP15 of the package PKG, and the data pads D8 through D15 in the memory module 100 of the MCP1 are connected to their corresponding external terminals DP24 through DP31.

Next, assume that the address data bit AD[24] is of a logic level 1 and the address data bit A[25] is of a logic level 0. Thus, the internal address bits Ain[24] and Ain[25] set for each of the MCP1 through MCP3 are represented as shown in FIG. 4:

MCP1: Ain[24]=1, Ain[25]=0

MCP2: Ain[24]=0, Ain[25]=0

MCP3: Ain[24]=1, Ain[25]=0

Thus, at this time, a chip select signal CS2 of a logic level 1 to make it possible to perform the input/output of data only by the input/output buffer groups 200₁ through 200₄ of the MCP2 and MCP3 lying in the MCP1 through MCP3 is generated as shown in FIG. 7. Further, at the two MCP2 and MCP3 selected from within the three memory chips MCP1 through MCP3, a low address area M_{L} of the memory module 100 in the MCP2 and a high address area M_{H} of the memory module 100 in the MCP3 are targeted for access (writing, reading) as shown in FIG. 16(b). With the operation of the data selector 300 made according to FIGS. 9, 13 and 14 at this time, the data pads D0 through D7 in the memory module 100 of the MCP3 are connected to their corresponding external terminals DP0 through DP7 of the package PKG as shown in FIG. 17, and the data pads D0 through D7 in the memory module 100 of the MCP2 are connected to their corresponding external terminals DP8 through DP15. Further, as shown in FIG. 17, the data pads D16 through D23 in the memory module 100 of the MCP3 are connected to their corresponding external terminals DP16 through DP23 of the package PKG, and the data pads D8 through D15 in the memory module 100 of the MCP2 are connected to their corresponding external terminals DP24 through DP31.

Next, assume that the address data bit AD[24] is of a logic level 0 and the address data bit A[25] is of a logic level 1. Thus, the internal address bits Ain[24] and Ain[25] set for each of the MCP1 through MCP3 are represented as shown in FIG. 4:

MCP1: Ain[24]=1, Ain[25]=1

MCP2: Ain[24]=1, Ain[25]=1

MCP3: Ain[24]=0, Ain[25]=1

Thus, at this time, a chip select signal CS2 of a logic level 1 to make it possible to perform the input/output of data only by the input/output buffer groups 200₁ through 200₄ of the MCP1 and MCP3 lying in the MCP1 through MCP3 is generated as shown in FIG. 7. Further, at the two MCP1 and MCP3 selected from within the three memory chips MCP1 through MCP3, a high address area M_{H} of the memory module 100 in the MCP1 and a low address area M_{L} of the memory module 100 in the MCP3 are targeted for access (writing, reading) as shown in FIG. 16(c). With the operation of the data selector 300 made according to FIGS. 9, 13 and 14 at this time, the data pads D0 through D7 in the memory module 100 of the MCP1 are connected to their corresponding external terminals DP0 through DP7 of the package PKG as shown in FIG. 17, and the data pads D8 through D15 in the memory module 100 of the MCP3 are connected to their corresponding external terminals DP8 through DP15. Further, as shown in FIG. 17, the data pads D8 through D15 in the memory module 100 of the MCP1 are connected to their corresponding external terminals DP16 through DP23 of the package PKG, and the data pads D24 through D31 in the memory module 100 of the MCP3 are connected to their corresponding external terminals DP24 through DP31.

Thus, according to the configuration as described above, simultaneous access can be made to two of three (odd number of) memory chips independent of one another. Therefore, the number of memory chips mounted within a signal package can be increased even in odd-numbered units as well as in even-numbered units without changing the number of page accesses. Accordingly, upon ensuring a desired storage area, the mounted number of memory chips can be reduced as compared with the case where the number of memory chips is increased only by the even-numbered units. A reduction in layout area with its reduction, and the stabilization of operation by a reduction in instantaneous current with minimization of the number of input/output buffers can be achieved.

While the preferred forms of the present invention have been described, it is to be understood that modifications will be apparent to those skilled in the art without departing from the spirit of the invention. The scope of the invention is to be determined solely by the following claims.

What is claimed is:

1. A data reading method suitable for use in a semiconductor memory device equipped with n (where n: positive integer) memory chips respectively having first and second storage areas, comprising the steps of:
sequentially selecting two memory chips in the way of combinations different from each other from within the n memory chips; and
reading data simultaneously from the first storage area of one of the two memory chips and the second storage area of the other thereof both selected by said chip selecting step.

2. The data reading method according to claim 1, wherein said n is odd.

3. The data reading method according to claim 1, wherein the first storage area is an area that belongs to each address lower than a predetermined address in a full storage area of each of the memory chips, and the second storage area is an area that belongs to each address higher than the predetermined address.

4. A data reading method suitable for use in a semiconductor memory device equipped with first through third memory chips respectively having first and second storage areas, comprising the steps:
a first step for simultaneously reading data from the first storage area of the first memory chip and the second storage area of the second memory chip;
a second step for simultaneously reading data from the second storage area of the third memory chip and the first storage area of the second memory chip; and
a third step for simultaneously reading data from the second storage area of the first memory chip and the first storage area of the third memory chip.

5. The data reading method according to claim 4, wherein the first storage area is an area that belongs to each address lower than a predetermined address in a full storage area of each of the first through third memory chips, and the second storage area is an area that belongs to each address higher than the predetermined address.

6. A semiconductor memory device comprising:
n (where n: positive integer) memory chips mounted therein, which respectively read data stored at addresses indicated by common address data according to the common address data,
wherein each of the memory chips includes:
a memory module having a first storage area and a second storage area, and
storage area switching means for switching one storage area to be targeted for reading according to the address data within the first and second storage areas to the other storage area according to a chip set bit.

7. The semiconductor memory device according to claim 6, wherein said n is odd.

8. The semiconductor memory device according to claim 6, wherein the first storage area is an area that belongs to each address lower than a predetermined address in a full storage area of each of the memory chips, and the second storage area is an area that belongs to each address higher than the predetermined address.
